(19) United States
(12) Patent Application Publication
(10) Pub. No.: US 2026/0329040 A1
(43) Pub. Date: Oct. 22, 2026

(54) DROP CLAMP FOR USE WITH FLAT FIBER CABLES

(71) Applicant: Allied Bolt, LLC, Bessemer, AL (US)

(72) Inventors: Roberto Sirotich, Boyton Beach, FL (US); Glen K. Malin, Purchase, NY (US)

(21) Appl. No.: 19/184,506

(22) Filed: Apr. 21, 2025

(51) Int. Cl. G02B 6/44

(52) U.S. Cl. CPC G02B 6/4439; G02B 6/4403

(57) ABSTRACT

A drop clamp that comprises a shell that has an elongated length between opposing first and second ends. The shell includes opposing spaced-apart sides and a curved bottom surface forming an interior longitudinal channel extending along a length of the shell. The interior longitudinal channel being defined between interior surfaces of the spaced apart sides and the curved bottom surface and having openings at the opposing first and second ends of the shell. The curved bottom surface has a concave profile having a recessed middle portion extending along a central longitudinal axis of the interior channel. The curved bottom surface bends upward from the recessed middle portion as it extends outward to bottom ends of each of the opposing spaced apart sides.

### FIELD

Embodiments presented herein relate generally to a drop clamp assembly for securing fiber-type drop communication wires or cables to a support structure, and more particularly to a drop clamp that can be optimally used for a flat fiber drop wire or cable.

### BACKGROUND

Drop wire clamps, or drop clamps, are a generally known piece of electrical pole-line hardware for supporting aerial/overhead power and telecommunication lines that link electrical power distribution or communication networks to building electrical systems. Such clamps can secure cables to anchor points along walls or facades of buildings or poles by griping the cable within a body portion of the clamp, with a bail wire of the clamp holding the cable in place under tension to prevent excessive sagging or strain on the connection points.

Generally, drop clamp assemblies can be installed by making a field connection of a fiber cable to the clamp components such as a wedge, shell, and shim. More particularly, customarily the cable can be manually inserted through an interior channel of the shell and the shim can be aligned and placed over the cable within the shell. While holding the shim in place in the proper alignment within the shell, a field worker can then typically insert the wedge into the shell over the shim and cable and pull the bail wire sliding the wedge through the shell until the wedge and shell become frictionally engaged with the wedge becoming lodged within the shell thus gripping the clamp around the cable such that the cable is between the shell and shim, with the bail wire extending outward from one end of the wedge. The bail wire can then typically be secured to an anchor point holding the cable in tension.

Drop cables come in various sizes and orientations to suit different needs of use or installation environments. Two common types of orientations for drop cables include ones that have a substantially round cross-sectional profile, and others having a flatter, rectangular or stadium-shaped cross-sectional profile that generally comprise rounded ends between elongated parallel sides. Flat fiber cables comprised of separate cylindrical or rectangular transmission segments in a joined alignment are also known. Such segments can be interposed between or adjacent to edge strength members which provide rigidity and reinforce the cable to keep it from buckling. Drop clamps can also vary in size to support different sized drop cables. When a round drop cable is being used, the cable is generally known to have a single diameter around its entire circumference, and thus the selection of a drop clamp can be easily made. More particularly, an appropriately sized clamp can be selected based off such single diameter to enable the cable to fit securely within the internal channel of the shell regardless of the rotation of the cable.

Unlike a round drop cable however, a flat drop cable does not have a single diameter on account that one dimension is usually larger than the other. In view of this distinction, a drop clamp having a shell selected to accommodate the larger dimension of a flat fiber cable may not provide sufficient engagement relative the cable which could enable the cable to slip within the clamp – thus causing the cable to lose tension or sag and require more frequent maintenance. Moreover, even if the clamp can be sufficiently engaged to the flat fiber cable, such engagement may take additional time and effort for a line worker to complete, including difficulty centering the flat cable in the channel. Such difficulties can lead to increased labor costs and higher chances of installation errors, which may compromise the stability and longevity of the connection.

Securing a flat fiber cable in a conventional drop clamp intended for a round cable can also result in uneven distribution of pressure on the cable by the shim and the serrated base of the clamp’s shell. Such uneven distribution of pressure during clamping the flat fiber cable can cause pressure to be exerted on the data transmitting fibers instead of the strength members of the cable which can compromise the integrity of the cable and the signal transmission therethrough, thus requiring replacement of the cable.

Given these challenges, there is a clear need for an improved drop clamp assembly for intended use with flat fiber cables, and more particularly for a clamp that can simplify the installation process and reduce the potential for installation errors or damage to the cable, to ultimately ensure a more secure and reliable connection. From the subject disclosure, persons of ordinary skill in the art will recognize and appreciate that embodiments presented herein can address the challenges of conventional drop clamps. More particularly, the utilization of a shell member having a curved base forming an internal channel with a concave bottom can aid in centering a flat cable within the clamp which can result in an even distribution of pressure onto the cable by the shim and the serrated base. Such capabilities can also better ensure that the pressure points from protrusions on the clamp’s shim or along the serrated concave base are exerted and distributed along the fiber cable’s edge strength members during clamping and not on the data transmitting fibers.

### BRIEF DESCRIPTION OF THE DRAWINGS

FIG. 1 is a schematic perspective view of a drop clamp assembly according to embodiments representatively presented herein.

FIG. 2A is a schematic perspective view of a shell of a drop clamp assembly according to embodiments representatively presented herein.

FIG. 2B is a schematic side elevation view of the shell of FIG. 2A.

FIGS. 2C and 2D are schematic end elevation views of the shell of FIG. 2A.

FIGS. 2E and 2F are schematic top and bottom plan views of the shell of FIG. 2A.

FIG. 3A is a schematic perspective view of a wedge of a drop clamp assembly according to embodiments representatively presented herein.

FIG. 3B is a schematic side elevation view of the wedge of FIG. 3A.

FIGS. 3C and 3D are schematic end elevation views of the wedge of FIG. 3A.

FIGS. 3E and 2F are schematic top and bottom plan views of the wedge of FIG. 3A.

FIG. 4A is a schematic perspective view of a shim of a drop clamp assembly according to embodiments representatively presented herein.

FIG. 4B is a schematic side elevation view of the shim of FIG. 4A.

FIGS. 4C and 4D are schematic end section views of the shim of FIG. 4A taken along the axis A-A of FIG. 4B.

FIGS. 4E and 4F are schematic top and bottom plan views of the shim of FIG. 4A.

### DETAILED DESCRIPTION

While the subject invention is susceptible of embodiment in many different forms, there are shown in the drawings, and will be described herein in specific detail, embodiments thereof with the understanding that the present disclosure is to be considered as an exemplification of the principles of the invention and is not intended to limit the invention to the specific embodiments illustrated.

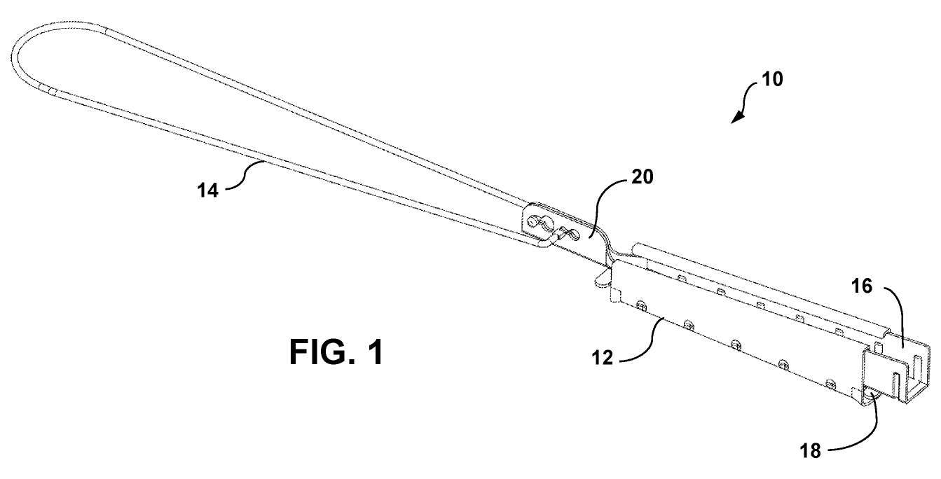

With reference now to the figures, FIG. 1 illustrates a drop clamp assembly 10 in assembled form according to embodiments representatively presented herein. As shown schematically in FIG. 1, the drop clamp assembly 10 can comprise a shell 12, a bail wire 14 secured to a wedge 16 and a shim member 18. According to embodiments shown representatively in FIG. 1, bail wire 14 can be comprised of a ridged wire rod forming a loop that can be secured to an anchor point along a building or other support structure. More particularly, bail wire 14 can be inserted through the eye of an anchor point in the nature of an eye bolt or other ring-like structure, and when clamp 10 is secured in place the anchor can hold the clamp around the curved distal end of the loop with the clamp holding the fiber cable in tension.

As shown schematically in FIG. 1, wire 14 can have a proximal end opposite the curved distal end. The proximal end of wire 14 can be comprised of wire ends that can each be secured to a flange 20 of the wedge 16. The fastening of the wire ends to flange 20 can close the loop of the bail wire as shown in FIG. 1. More particularly, the wire ends can be inserted into slots or openings extending through flange 20. The openings can be sized to closely accommodate the diameter of bail wire 14 for frictional engagement of the wire ends within the openings. The wire ends can be fastened in place by way of mechanical fasteners such as nuts, and/or can have openings proximate their terminal ends to receive a stake or pin that can engage against the side of flange 20 to maintain engagement of the wire ends within the openings of flange 20.

According to embodiments shown representatively in FIG. 1, in an assembled state, the shim 18 of clamp 10 can be positioned between shell 12 and wedge 16, with both shim 18 and wedge 16 engaged within an interior channel of the shell 12. According to embodiments representatively presented herein, the drop clamp assembly 10, including the shell 12, shim 18 and wedge 16 can be stamped from high-strength stainless steel, and the bail wire 14 can be formed from soft stainless steel, however other durable materials can be used without limitation.

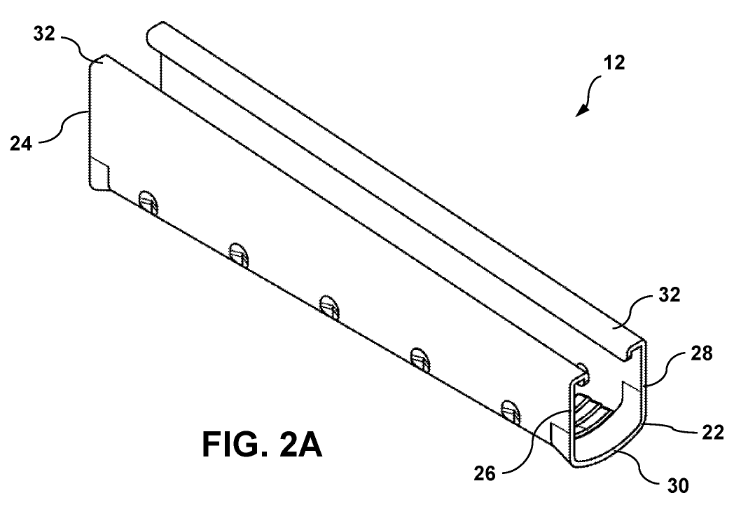

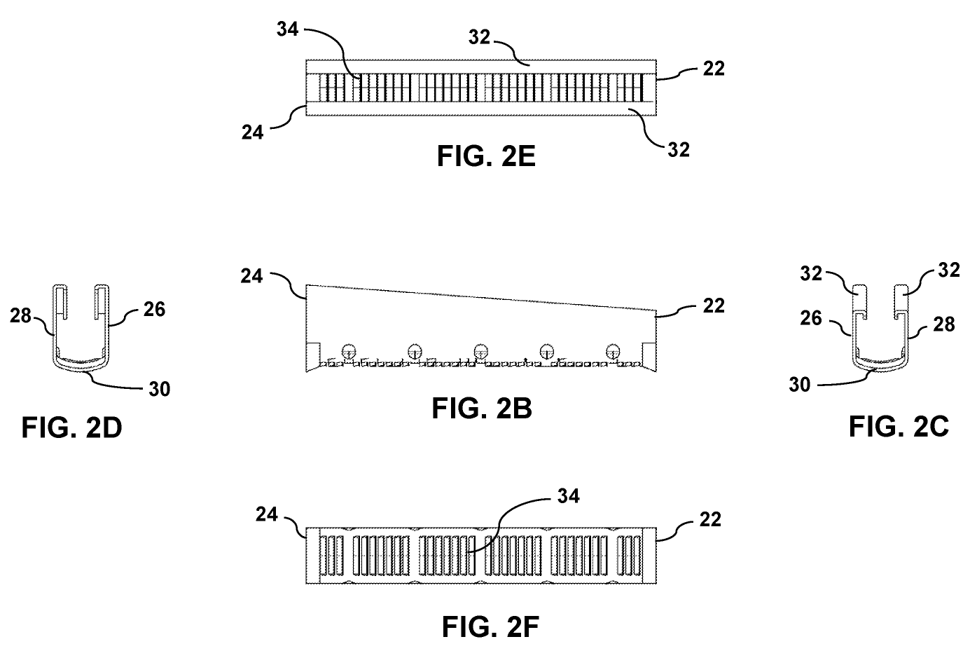

FIGS. 2A through 2F schematically illustrate a shell 12 according to embodiments representatively presented herein. As shown schematically in FIGS. 2A through 2F, shell 12 can have an elongated length between opposing first and second ends 22, 24, and as best shown in FIGS. 2C and 2D comprise a profile having a generally U-shaped configuration formed by opposing spaced-apart sides 26, 28 and a curved base 30 therebetween. The opposing sides 26, 28 of the shell 12 can extend upward from the sides of base 30 and be substantially parallel as shown in FIGS. 2C and 2D, or can be pitched outward as desired (not shown). Together, the opposing sides 26, 28 and base 20 of shell 12 can form an interior channel extending along the length of the shell with openings at each of the opposing ends 22, 24.

As best shown in FIG. 2B, the opposing sides 26, 28 of shell 12 can increase in height as they extend along the length of the shell 12 between the first end 22 and the second end 24, and conversely the height of shell 12 can taper as it extends from the second end 24 to the first end 22. According to exemplary embodiments best shown in FIGS. 2C and 2D, the top ends of opposing sides 26, 28 can comprise flanges 32 that can be integrally formed along at least a portion of the length of each of the opposing sides 26, 28. Flanges 32 can have a first segment that can extend inward from the top ends of the opposing sides 26, 28 toward one another and a second segment that cam extend downward toward the curved base 30 to comprise a hooked or bent configuration defining a retaining surface along the bottom of the first segment. The flanges 32 along the top of the opposing sides 26, 28 can be spaced apart with a slotted opening therebetween. Such slotted opening can provide access to the interior channel of the shell 12.

As best shown in the top and bottom plan views of FIGS. 2E and 2F, the base 30 of shell 12, including at least the top/interior side thereof, can have a coarse or serrated surface 34. According to embodiments shown schematically in FIGS. 2E and 2F, the serrated surface 34 can be comprised of a pattern or series of small sharp, tooth-like projections or notches that can extend upward into the interior channel of shell 12. As will further understood from the following description, such serrations are configured to increase frictional engagement between the base 30 of 12 shell and a fiber cable received with in the shell when the wedge 16 is slidingly engaged within the shell 12 to ensure a secure hold or grip between the shell 12, the fiber cable and the shim/wedge 16, 18.

As best shown in FIGS. 2A through 2D, the ends of the shell 12 can have flared bottom edges which can comprise an angled surface that can slope downward from the serrated surface 34. Such flared ends can enable the cable to avoid contact with the sharp bottom end edges along of the shell when the cable is retained within the clamp and pressed between the base of shell 12 and the underside of the shim 18. Such edges can prevent the outer jacket of a cable from tearing or fraying which can damage the optical fibers which can impede signal transmission or require more frequent replacement.

According to embodiments representatively shown in FIGS. 2C and 2D, the base 30 of shell 12 can comprise an interior surface having a curved shape along its length such that the elongated middle portion is recessed from the side portions. More particularly, the base 30, or at least the interior surface thereof, can bend downward from the bottom of opposing sides 26, 28 of the shell to the middle portion which can be aligned along a central longitudinal axis of the shell 12. Accordingly, the curved base 20 can provide the interior channel with a U-shaped profile along at least a portion of its length. Described further, the curved bottom surface can have a concave profile having a recessed middle portion extending along a central longitudinal axis of the interior channel. The curved bottom surface can bend upward from the recessed middle portion as it extends outward to the bottom of each of the opposing spaced apart sides.

Persons of ordinary skill in the art will recognize that such profile can better correspond to the shape of certain flat fiber cables on account that the bottom of the channel is curved and able to more closely conform to rounded side edges of the cable when received therein, with the straight sides 26, 28 of channel being better suited to conform to substantially flat or straighter sides of such flat cable. Thus, as will be further understood from the following disclosure, a shell having an internal channel with such configuration can better accommodate and secure a flat fiber cable within the clamp and prevent the cable from slipping or becoming disengaged within the clamp. More particularly, the concave bottom surface of the interior channel of shell 12 can facilitate ease of centering the cable within the clamp 10 resulting in even distribution of pressure onto the cable by the shim 18 and serrations 34 along the base 30 of the shell. Such configuration can further help ensure that pressure points from protrusions on the shim and the serrations along the concave base 30 are more directly exerted on the cable’s edge strength members during clamping and not on the data transmitting fibers. The more even distribution of pressure upon the strength members can maintain the integrity of a flat fiber cable and avoid damage to the transmission members which can lead to poor signal conveyance and require replacement of the cable.

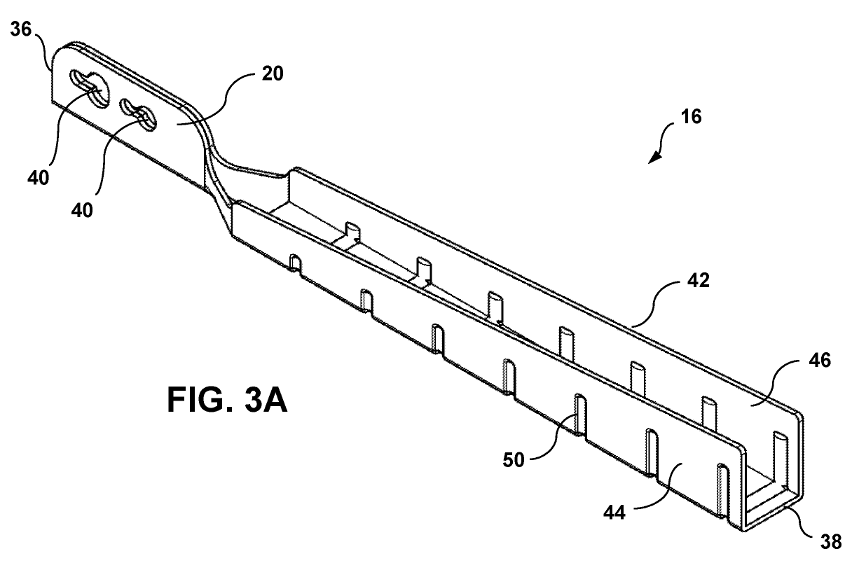

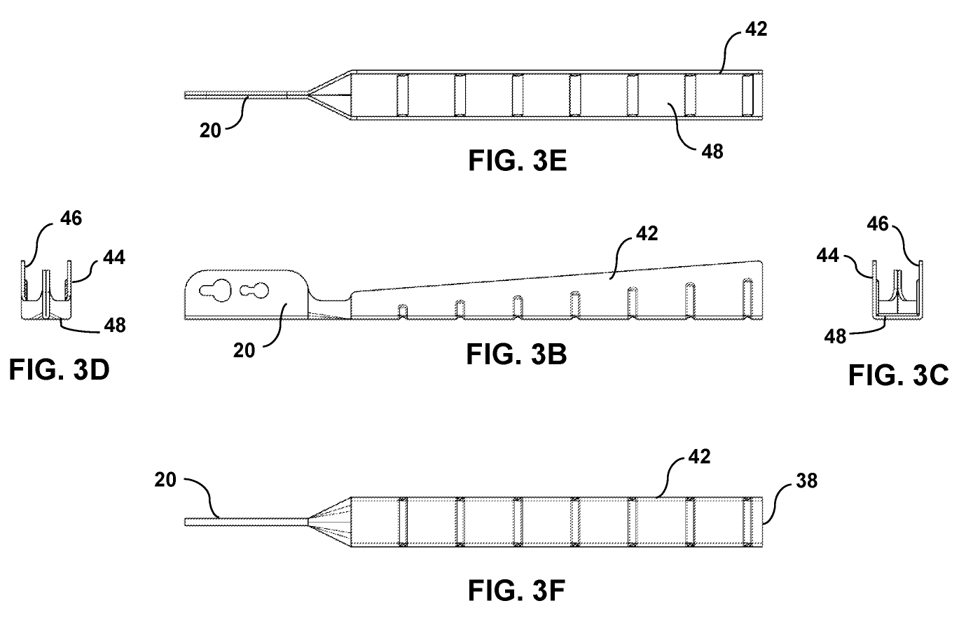

FIGS. 3A through 3F schematically illustrate a wedge 16 according to embodiments representatively presented herein. As shown schematically in FIGS. 3A through 3F, wedge 16 can have an elongated length between opposing first and second ends 36, 38. As described above relative FIG. 1, a flange 20 can be located adjacent the first end 36 of wedge 16. Flange 20 can have flat side surfaces with openings 40 therethrough which can receive the ends of a bail wire. A wedge portion 42 can be located adjacent the second end 38 of wedge 16. As best shown in FIGS. 3A through 3C, wedge portion 42 can have a profile having a generally U-shaped configuration formed by substantially straight opposing sides 44, 46 and a substantially flat base 48 therebetween. The sides 44, 46 of the wedge portion 42 can extend upward from the sides of base 48 and be substantially parallel as best shown in FIGS. 2C and 2D to correspond to the profile of the shell, or can be pitched outward where the shell is so configured (not shown). Wedge portion 42 can additionally have a plurality of cross grooves 50 that can extend across the outer surface of the base 48 and upward along at least a portion of the exterior surfaces of sides 44, 46. Such cross-grooves can provide a plurality of recesses substantially perpendicular to the length of wedge portion 48 along the exterior surfaces of the base and sides of wedge portion 42.

According to embodiments representatively shown in FIGS. 3A and 3B, the opposing sides 44, 46 of the wedge portion 42 can increase in height as they extend along at least a portion of the length of the wedge portion towards the second end 38 of wedge 16. Thus, sides 44, 46 can have a top edge that slopes downward as it extends away from the second edge 38. Such wedged or sloped configuration facilitates frictional engagement of the wedge 16 relative the shell 12 when the clamp 10 is assembled and secured together. More particularly, in ordinary use, a line worker securing wedge 15 into shell 12 can insert the first end 36 of wedge 16 through the second end 24 of the shall 12, such that at least a portion of the sides 44, 46 of the wedge portion 42 are below at least a portion of the flanges 32 of the shell 12. Once the wedge 16 is introduced into shell 12, wedge 12 can be slidingly moved along the length of shell 12 toward the first shorter end 22 of the shell. Such movement of the wedge 16 relative shell 12 can permit the sloping top surface of the sides 44, 46 of the wedge portion 42 to engage along the sloping bottom retaining surface of the shell flanges 32 causing the wedge portion 42 to become frictionally wedged in the interior channel of shell 12.

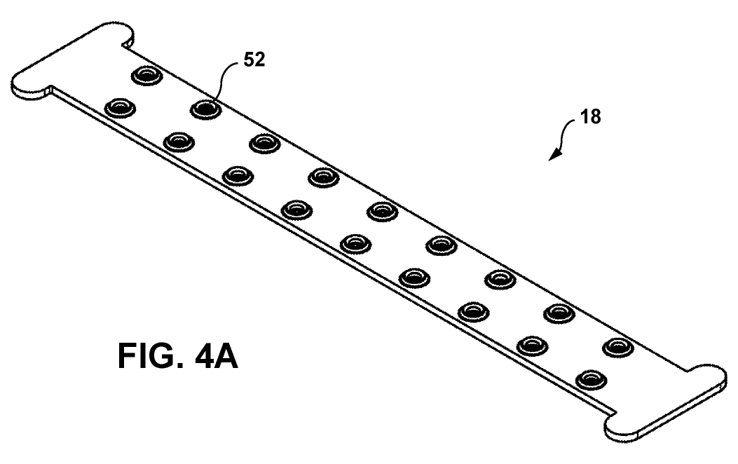

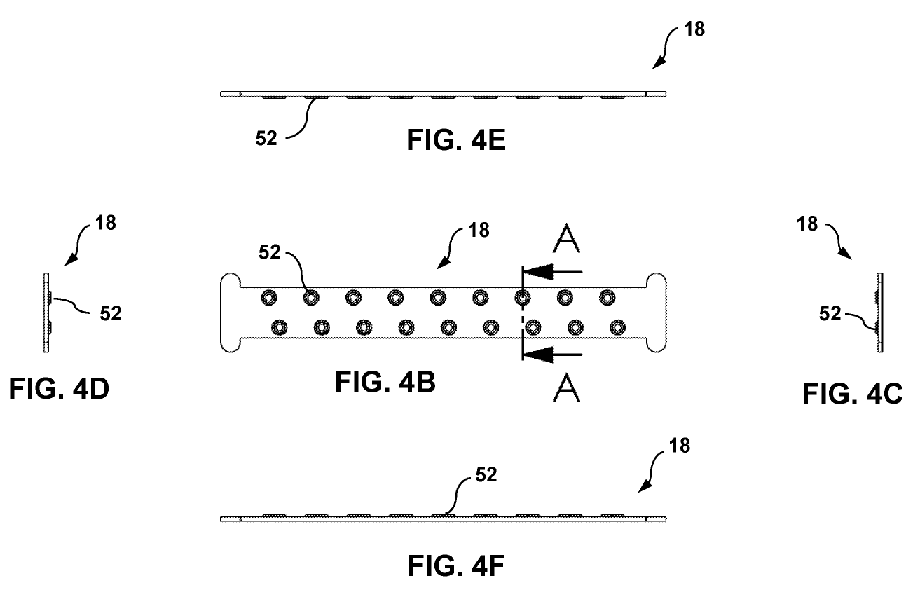

FIGS. 4A through 4F illustrate a shim 18 of the drop clamp 10 according to embodiments representatively presented herein. As shown schematically in FIG. 4A, shim 18 can comprise an elongated strip having opposing top and bottom surfaces and an elongated body portion between opposing first and second ends. According to embodiments best shown representatively in FIGS. 4A and 4B, shim 18 can have a generally “dog-bone” shape having an elongated middle portion between opposing end portions whereby the middle portion has a narrower width than the end portions adjacent the opposing respective first and second ends. Shim 18 can be sized to correspond to the size of the shell such that the elongated middle portion can be received and fit within the internal channel of shell 12 and have a length that extends the full length of the interior channel of shell such that the end portions of shim 18 can be positioned outside the opposing ends of the shell 12. Thus, the wider ends shell 18 can be useful to preventing the shim from sliding along the length of shell when the wedge is slidingly engaged within the shell.

According to representative embodiments best shown in FIGS. 4A through 4F, the middle portion of shim 18 can have a dimpled surface comprising a plurality of notches 52 that can provide shim 18 with an uneven or serrated surface along at least the bottom side of shim. As shown schematically in FIGS. 4A through 4F, notches 52 can be provided in a pattern of circular projections that extend outward from the bottom surface of the shim 18. It will be understood however that such notches 52 can have alternate shapes, sizes, orientations or patters without departing from the scope of embodiments presented herein. In use, when a fiber cable is inserted and received within the interior channel of shell 12, the shim 18 can be placed over the top of the cable with the downwardly extending notches 52 being engaged against the outer surface of the cable. Upon wedge 16 being engaged within the shell 12, notches 52 can improve the frictional grip between the shim 18 and the cable to better facilitate a secure hold or between the shell cable and the clamp 12.

From the foregoing it will be appreciated that the assembly of the first piece of the drop clamp can be undertaken prior to installing the drop clamp in the field, and thus during installation a field worker only has to handle two pieces of the drop clamp instead of three (or more). More particularly, in use a line worker can insert an aerial drop wire through the shell, and once inserted align the first piece of the drop clamp with the shell by positioning the first tapered end of the wedge with the second end of the shell that has taller/larger side panels forming a deeper interior channel.

Further, logic flows depicted in the figures do not require the particular order shown, or sequential order, to achieve desirable results. Other steps may be provided, or steps may be eliminated, from the described flows, and other components may be add to, or removed from the described embodiments.

What is claimed is:

1. A drop clamp comprising:
a shell having an elongated length between opposing first and second ends, the shell including opposing spaced-apart sides and a curved bottom surface forming an interior longitudinal channel extending along the length of the shell, the interior longitudinal channel being defined between interior surfaces of the spaced apart sides and the curved bottom surface and having openings at the opposing first and second ends of the shell, the curved bottom surface having a concave profile having a recessed middle portion extending along a central longitudinal axis of the interior channel, the curved bottom surface bending upward from the recessed middle portion as it extends outward to bottom ends of each of the opposing spaced apart sides.

2. The drop clamp of claim 1 further comprising a wedge configured to be slidingly engaged within the interior longitudinal channel of the shell, the wedge having first and second ends with an elongated length therebetween, a flange being adjacent the first end of the wedge, the flange having a surface for a bail wire being coupled thereto, a wedge portion being adjacent the second end of the wedge, the wedge portion having a U-shaped cross-sectional profile defined by substantially straight opposing sides and a base therebetween, the opposing sides of the wedge portion tapering in height as they extend away from the second end of the wedge such that the opposing sides of the wedge are taller adjacent the second edge of the wedge and slope downward as the opposing sides extend toward the first end of the wedge.

3. The drop clamp of claim 1 further comprising a shim having an elongated middle portion between opposing first and second longitudinal ends, the elongated middle portion of the shim being positionable within the interior longitudinal channel of the shell with the longitudinal ends of the shim extending outside the respective openings at the opposing first and second ends of the shell.

4. The drop clamp of claim 1 wherein the opposing spaced-apart sides of the shell comprise a top portion having flanges integrally formed along at least a portion of a length thereof, the flanges having first and second segments, the first segment extending inward from the top portion of the opposing spaced-apart sides toward the central longitudinal axis of the interior channel and the second segment extending from a terminal end of the first segment downward toward the curved bottom surface, a retaining surface being defined along a bottom surface of the first segment.

5. The drop clamp of claim 1 wherein at least a portion of the curved bottom surface of the shell has a serrated surface comprised of a plurality of projections extending upward toward the interior longitudinal channel.

6. The drop clamp of claim 1 wherein the shell has a U-shaped cross-sectional profile defined by the curved bottom surface and the opposing spaced-apart sides which are substantially parallel to one another, the opposing spaced-apart sides of the shell tapering in height as they extend between the second and first opposing ends of the shell such that the opposing spaced-apart sides have a height that is taller at the second end of the shell than at the first end of the shell and the opening of the internal longitudinal channel is larger at the second end of the shell than the opening at the first end of the shall.

7. The drop clamp of claim 2 further comprising a bail wire securable to the flange of the wedge, the bail wire having proximal and distal ends, the proximal end configured for being secured to the flange and the distal end comprising a loop configured for being secured through an attachment member.

8. The drop clamp of claim 3 wherein the shim has a bottom surface comprising a plurality of notches that extend outward therefrom, the plurality of notches configured for engagement with a cable received in the interior longitudinal channel of the shell.

9. The drop clamp of claim 4 further comprising a slotted opening between the flanges of the opposing-spaced apart sides, wherein the interior longitudinal channel is accessible through a top of the shell through the slotted opening.

10. A drop clamp comprising:
a shell having an elongated length between opposing first and second ends, the shell including opposing spaced-apart sides and a curved bottom surface forming an interior longitudinal channel extending along the length of the shell, the interior longitudinal channel being defined between interior surfaces of the spaced apart sides and the curved bottom surface and having openings at the opposing first and second ends of the shell, the curved bottom surface having a concave profile having a recessed middle portion extending along a central longitudinal axis of the interior channel, the curved bottom surface bending upward from the recessed middle portion as it extends outward to bottom ends of each of the opposing spaced apart side, and wherein the shell has a U-shaped cross-sectional profile defined by the curved bottom surface and the opposing spaced-apart sides which are substantially parallel to one another, the opposing spaced-apart sides of the shell tapering in height as they extend between the second and first opposing ends of the shell such that the opposing spaced-apart sides have a height that is taller at the second end of the shell than at the first end of the shell and the opening of the internal longitudinal channel is larger at the second end of the shell than the opening at the first end of the shall.
a wedge configured to be slidingly engaged within the interior longitudinal channel of the shell, the wedge having first and second ends with an elongated length therebetween, a flange being adjacent the first end of the wedge, the flange having a surface for a bail wire being coupled thereto, a wedge portion being adjacent the second end of the wedge, the wedge portion having a U-shaped cross-sectional profile formed by substantially straight opposing sides and a base therebetween, the opposing sides of the wedge portion tapering in height as they extend away from the second end of the wedge such that the opposing sides of the wedge are taller adjacent the second edge of the wedge and slope downward as the opposing sides extend toward the first end of the wedge.
a shim having an elongated middle portion between opposing first and second longitudinal ends, the elongated middle portion of the shim being positionable within the interior longitudinal channel of the shell with the longitudinal ends of the shim extending outside the respective openings at the opposing first and second ends of the shell.

11. The drop clamp of claim 10 wherein the opposing spaced-apart sides of the shell comprise a top portion having flanges integrally formed along at least a portion of a length thereof, the flanges having first and second segments, the first segment extending inward from the top portion of the opposing spaced-apart sides toward the central longitudinal axis of the interior channel and the second segment extending from a terminal end of the first segment downward toward the curved bottom surface, a retaining surface being defined along a bottom surface of the first segment.

12. The drop clamp of claim 10 wherein at least a portion of the curved bottom surface of the shell has a serrated surface comprised of a plurality of projections extending upward toward the interior longitudinal channel.

13. The drop clamp of claim 10 further comprising a bail wire securable to the flange of the wedge, the bail wire having proximal and distal ends, the proximal end configured for being secured to the flange and the distal end comprising a loop configured for being secured through an attachment member.

14. The drop clamp of claim 10 wherein the shim has a bottom surface comprising a plurality of notches that extend outward therefrom, the plurality of notches configured for engagement with a cable received in the interior longitudinal channel of the shell.

15. The drop clamp of claim 10 further comprising a slotted opening between the flanges of the opposing-spaced apart sides, wherein the interior longitudinal channel is accessible through a top of the shell through the slotted opening.

16. The drop clamp of claim 11 wherein at least a portion of the wedge portion is configured for being received by the shell and being slidably engaged along the interior longitudinal channel thereof, the wedge portion being configured to be introduced into the interior longitudinal channel through the opening at the second end of the shell, the retaining surface of the flanges being configured to engage with top surfaces of the opposing sides of the wedge portion as the wedge portion and shell slidingly engage relative each other as the wedge potion is moved toward the first end of the shell, the wedge portion being configured for being frictionally secured in the interior longitudinal channel by said slidingly engagement.

17. The drop clamp of claim 15 wherein the interior longitudinal channel of the shell is configured for receiving the shim through the slotted opening between the flanges.

18. A shell for a drop clamp assembly comprising an elongated length between opposing first and second ends, the shell including opposing spaced-apart sides and a curved bottom surface forming an interior longitudinal channel extending along the length of the shell, the interior longitudinal channel being defined between interior surfaces of the spaced apart sides and the curved bottom surface and having openings at the opposing first and second ends of the shell, the curved bottom surface having a concave profile having a recessed middle portion extending along a central longitudinal axis of the interior channel, the curved bottom surface bending upward from the recessed middle portion as it extends outward to bottom ends of each of the opposing spaced apart side, and wherein the shell has a U-shaped cross-sectional profile defined by the curved bottom surface and the opposing spaced-apart sides which are substantially parallel to one another, the opposing spaced-apart sides of the shell tapering in height as they extend between the second and first opposing ends of the shell such that the opposing spaced-apart sides have a height that is taller at the second end of the shell than at the first end of the shell and the opening of the internal longitudinal channel is larger at the second end of the shell than the opening at the first end of the shall.

19. The shell of claim 18 wherein the opposing spaced-apart sides of the shell comprise a top portion having flanges integrally formed along at least a portion of a length thereof, the flanges having first and second segments, the first segment extending inward from the top portion of the opposing spaced-apart sides toward the central longitudinal axis of the interior channel and the second segment extending from a terminal end of the first segment downward toward the curved bottom surface, a retaining surface being defined along a bottom surface of the first segment.

20. The shell of claim 19 wherein at least a portion of the curved bottom surface has a serrated surface comprised of a plurality of projections extending upward toward the interior longitudinal channel, and wherein a slotted opening is provided between the flanges of the opposing-spaced apart sides, and the interior longitudinal channel is accessible through a top of the shell through the slotted opening.
